(19) United States
(12) Patent Application Publication
(10) Pub. No.: US 2013/0211857 A1
(43) Pub. Date: Aug. 15, 2013

(54) MEDICATION REFILL ADVISOR SYSTEM AND METHOD

(71) Applicant: REFILL MANAGEMENT SYSTEMS, LLC, (US)

(72) Inventors: Jeffrey Scott Patch, Yarmouth, ME (US); Craig Bossie, Westbrook, ME (US); Kevin John Paquet, Biddeford, ME (US); Jason Lenardson, Yarmouth, ME (US); Christopher Claudio, Yarmouth, ME (US); Michael Williams, Harpswell, ME (US)

(73) Assignee: REFILL MANAGEMENT SYSTEMS, LLC, Yarmouth, ME (US)

(21) Appl. No.: 13/846,497

(22) Filed: Mar. 18, 2013

Related U.S. Application Data
(63) Continuation of application No. 12/790,210, filed on May 28, 2010.
(60) Provisional application No. 61/181,823, filed on May 28, 2009.
(60) Provisional application No. 61/249,907, filed on Oct. 8, 2009.

(51) Int. Cl. G06F 19/00; G06Q 50/24

(52) U.S. Cl. CPC G06F 19/3456; G06Q 50/24
USPC 705/3

(57) ABSTRACT

A system and method for automated medication refill are provided, wherein the system and method reduce the time spent on, and potential for error in, accommodating medication refill requests. In one embodiment, the system includes a computer device for executing a medication information input function, a patient information input function, a refill protocol determination function, a refill analysis function, and an automated refill advisory output function. In a preferred embodiment, the system also executes an automatic pharmacy refill authorization function. The system includes a database incorporated therein or in electronic communication therewith. The system and method of the present invention provide a mechanism for medication refill protocols that provides specific patient care guidance for prescribed medications.

### CROSS-REFERENCE TO RELATED APPLICATION

The present invention relates to, and claims priority in, pending nonprovisional U.S. patent application Ser. No. 12/790,210, entitled “MEDICATION REFILL ADVISOR SYSTEM AND METHOD filed May 28, 2010 by the same inventors and assigned to a common assignee, which prior pending application claims the priority benefit of U.S. Provisional Patent Application Ser. No. 61/181,823, entitled “SYSTEM AND METHOD FOR MEDICATION REFILL ADVISOR” filed May 28, 2009 by one of the same inventors, and U.S. Provisional Patent Application Ser. No. 61/249,907, entitled “SYSTEM AND METHOD FOR MEDICATION REFILLS” filed Oct. 8, 2009 by one of the same inventors. The contents of the related applications are incorporated herein by reference.

### BACKGROUND OF THE INVENTION

1. Field of the Invention

The present invention relates to software programs to assist health care providers tasked with prescribing or filling medication refills. More particularly, the present invention relates to the integration of patient-specific records with medication information to produce appropriate medication refill guidelines and related patient care. The present invention is related to a computer-based system and related method for implementing efficient, automated medication refill procedures.

2. Description of the Prior Art

As the U.S. patient population ages, there will be an increasing number of patients on multiple medications, each of which has the potential to do harm to the patient if not monitored. In addition, advances in disease management will continuously generate new pharmaceuticals which will have specific monitoring parameters. Presently, there are over one thousand unique medications and tens of thousands of variations of those unique medications.

As part of the approval process, medications are reviewed for safety and specific recommendations are made by the manufacturer and the Food and Drug Administration (FDA) for routine laboratory and vital statistics monitoring. In addition, national organizations, such as the American Heart Association, publish guidelines for routine monitoring of prescription medication. As data about these medications and the clinical conditions they treat are updated and changed, these recommendations and guidelines are adjusted to reflect these data. While these recommendations and guidelines are available to clinicians through a variety of sources, the data are presented primarily in text format, which is not amenable to electronic analysis and decision support. The local practice may also have a defined rule set or recommendation protocol system for medication refills in a different source that the clinician must access. Because these data are stored in disparate sources, it is cumbersome to track and utilize these recommendations.

With the widening adoption of electronic health records, clinicians will be better positioned to use electronic decision support tools to improve the efficiency and quality of care, requiring less staff to perform record keeping functions. Presently, most electronic health records contain the means for electronic communication with pharmacies, laboratories and even patients. They also store prescription information, laboratory and clinical results, visit history, and vital signs in a format that is searchable and amenable to electronic decision support tools. While there have been advances in electronic record keeping, much information relevant to patient care and medication prescribing remains stored in separate locations of a broad array of disparate types of file storage options. This makes the application of a medication monitoring system difficult to do electronically or in an organized, efficient manner. As a result, to the extent effective medication monitoring is performed, it is mainly done manually and on an inconsistent basis. For example, to evaluate a medication refill which requires periodic blood testing, office visits, and vital sign evaluation, a clinician may have to view four separate portions of the electronic record as well as look up the monitoring recommendations for that medication in another source(s) completely.

Some electronic health records have a system to alert a clinician if a medication has to be refilled. A growing number of electronic health record applications have disease based alert systems to prompt the clinician for necessary testing. These alert systems typically are in the form of sidebar or pop up screens which appear on a monitor available to the health care provider during a review of the electronic records in the course of an office visit by the patient. While this is a useful tool for the clinician during an office visit, it overlooks the fact that the vast majority of refill requests occur outside of office visits with the patient. Generally, they are telephone or electronic encounters initiated by the patient or the local pharmacy. These encounters are generally handled initially by medical assistants or nurses who have less familiarity with the variety of medications and their testing requirements. Added to the complexity is the combination of generic and brand names used when referring to medication, as well as specific laboratory test results that perhaps should be considered in the refill analysis, which results may be located in any of a number of testing panels. In the absence of an intelligent decision support tool, the burden of work and the potential for refill error is quite high. For example, a specific practice encompassing 25 internists can receive on average up to six hundred refill requests per day. As such, the number of medication refill requests can easily exceed 50,000 annually in such a practice. Even a small error rate is likely to produce a significant amount of error. It has been determined that it can take from one to five minutes to fully evaluate a medication refill request based on the complexity of the request and using an internally generated (i.e., customized) refill protocol. The burden of this work effectively equals four full-time staff just to manage medication refills.

What is needed is a system and related method to organize and coordinate patient and medication information to reduce the time spent in accommodating refill requests and that are configured to reduce the possibility of making refill errors. Such a system and method preferably integrate electronic patient records of all types with up-to-date medication information. Further, what is needed is a system and method that provide a standardized, automated mechanism for medication refill protocols and that account for specific patient care guidance associated with prescribed medication information.

### SUMMARY

It is an object of the present invention to provide a system and related method to reduce the time spent on, and potential for error in, accommodating refill requests. This object is achieved by organizing and coordinating patient and medication information and improving the exchange of prescription information between health care providers (including pharmacists) and patients. The present invention preferably integrates electronic patient records of all types with medication information that is updated on a timely basis. Further, it is an object of the present invention to establish a system and method that provides a standardized mechanism for automated medication refill protocols and that accounts for specific patient care guidance associated with prescribed medication information.

These and other objects are achieved in the present invention, which is a computer-based medication refill advisor and interface system and related method. The system and method are configured to enable a user to gather and store information and perform manipulations on that information to produce outcomes. The system and method are also configured to establish an interface among at least a pharmacy medication management system, an electronic health record (both individual and centralized Electronic Medical Record data exchange), a source of national monitoring recommendations, and a source of refill instructions which are provider-customizable.

The system and corresponding method are computer-based and enable a user to respond to patient medication refill requests in a manner understandable by any type of health care provider including, but not limited to clinicians, pharmacists, medical assistants, nurses, and support staff. The system gathers medication data and patient data and establishes protocols for completing the medication refill process, and includes a patient care attribute. A patient care attribute is the specific refill protocol established for a particular patient based on that patient's medical information. The system includes standardized protocols for implementing medication refill instructions but also permits user modification of parameters to satisfy the requirements of the specific clinicians using the system.

In one embodiment, the present invention includes an aggregation of medication information and medication monitoring recommendations from various sources which are encoded into a protocol database arranged to allow for electronic analysis and comparison with clinical data. The specific protocol database may be part of a general electronic health record (EHR) database, but may also be or form part of a national or international standards organization database. It may also be independent.

In another embodiment, the present invention provides an automated clinical analysis application to facilitate the analysis of medication refill requirements in comparison with actual patient data, and subsequently offers recommendations for action based on that analysis. This system includes a processor configured to accept electronic and manually entered refill requests, compare the parameters for that specific medication against an established protocol, and make automated recommendations. The system includes a user interface with one or more computer program-based electronic prescribing applications, electronic health records and a database containing recommendations for prescription medication monitoring. The present invention can be used in conjunction with electronic prescribing applications, electronic health record programs, and databases known in the art.

In another embodiment, the system presents to the user an interface containing relevant data and recommendations. From that same interface, the user can execute the necessary tasks recommended to complete the refill transaction. These tasks link to the underlying electronic medical record where the data are stored for record keeping purposes.

In another embodiment, the medication refill advisor system of the present invention is configured to automatically authorize the pharmacy to refill a medication on a selectable basis, such as a 90-day basis, for example, provided that the medication is verified to be active on the patient's current medication list and that the patient is currently active on the patient's health care provider's panel. The system is configured so that, with each refill request sent to a pharmacy, the health care provider is notified about the refill request and a report is generated of the national recommendations regarding monitoring and the patient's status with respect to the provider's own refill instructions. If the patient is in complete compliance, the report generated signals a “go” or green flag on the refill function and no further action is required on the part of the health care provider or the pharmacist, other than to complete the refill. If the report generates a “caution” signal or the report is flagged yellow, then some sort of activity must occur within the selectable basis window. For example, the patient may have to come in for a blood pressure check before any further refill occurs. If the report generates a “stop” signal or red flag, then the patient is notified that some overdue action must be completed and the refill requires a specific authorization from the patient's provider to continue the medication until the action has been completed.

Through use of this embodiment of the present invention, a patient only has to call the pharmacy to request the refill. Pharmacies do not have to wait for provider approval and thereby make their workflow more efficient. Specifically, after the patient calls the pharmacy to request a refill, the pharmacy uses the refill advisor system to communicate electronically with the doctor's office to authorize the refill, and if a green flag or “go” signal results, the pharmacy refills the prescription. If necessary, the doctor contacts the patient to advise on any follow-up action needed such as testing or an office visit. As a result, the number of phone calls to the health care provider drops significantly and the quality of the refill process improves as patient status reviews are conducted more regularly, such as at the 90-day occurrence rather than yearly or less regularly as is currently the case. The present system and related method are essential to move the refill process from the doctor's office to the pharmacy, making the process automatic and not user dependent.

The system and method of the present invention enable pharmacists and health care providers to provide patients with rapid and effective responses to medication refill requests. They also ensure that the information associated with making refill decisions is up-to-date and comprehensive. At the same time, the invention enables clinicians and pharmacists to amend the refill instructions as determined based on the information aggregated for the patient and the medication at an easy-to-understand interface. These and other advantages and features of the system and method of the present invention will become apparent to those skilled in the art upon review of the following detailed description, the accompanying drawings and the appended claims.

### BRIEF DESCRIPTION OF THE DRAWINGS

FIG. 1 is a simplified representation of a computer system suitable for performing the functions and steps embodied in the refill advisor system and method of the present invention.

FIG. 2 is a simplified block representation of the system of the present invention and its primary functional components.

FIG. 3 is a simplified block representation of the functional interfaces of the present invention.

FIG. 4 is a simplified flow diagram of the work flow of the refill protocol determination function of the system and method of the present invention, illustrating sample inputs and resulting actions occurring during the process of generating protocols for medications.

FIG. 5 is a simplified flow diagram of an example of the work flow used to carry out a refill analysis by the system of the present invention.

FIGS. 6A-C are a flow diagram of a review carried out by a clinician to determine the applicability of a refill recommendation generated by the refill analysis.

FIG. 7 is a sample representation of a user interface of the system of the present invention arranged to allow the user to conduct a refill advisory protocol analysis for a patient.

FIG. 8 is a first sample report of patient medication refill advisory information.

FIG. 9 is a second sample report of patient medication refill advisory information.

### DETAILED DESCRIPTION OF THE PREFERRED EMBODIMENTS

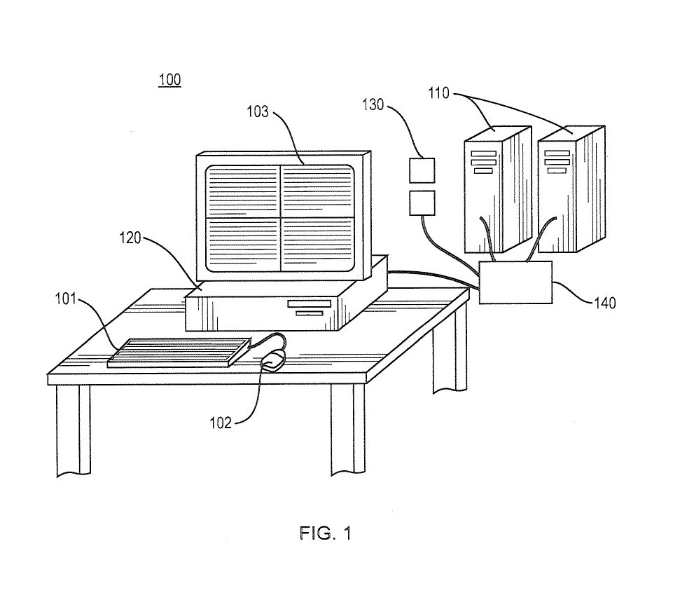

The present invention is a system and method configured to enable pharmacists and health care providers to work together in a highly efficient manner to provide patients with rapid and effective responses to medication refill requests. The refill advice provided is made with up-to-date and comprehensive information about medications, patients and their care. The system of the present invention is a set of functions embodied in computing means for executing primary actions associated with the method to be described herein. FIG. 1 shows a representation of computing means suitable for executing the functions of the system, a computer system 100. The computer system 100 shown is only one example of a suitable computing means and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented by desktop computer 120, for example. Examples of well known computing means that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. The computing means represented by computer system 100 may include computer devices operated by one or more users, such as through a desktop, laptop, or servers, and/or one or more providers of services corresponding to one or more functions of the invention.

The server 110, the computer processor 120, or a combination of both may be programmed to include one or more of the functions of the invention system. One or more databases represented by database 130 that may be associated with the server 110, the computer processor 120, other computing devices, or any combination thereof, include information related to the use of the invention system. For example, the database 130 may include information of importance to the user. The database 130 may be populated and updated with information provided by an application provider capable of carrying out one or more of the steps associated with the system of the invention, one or more businesses, or any other information providers. All of the devices may be interconnected through one or more signal exchange devices, such as router/switch 140.

The invention may be described in the general context of computer-executable instructions, such as program modules, being executed by a computer.

Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer system 100.

The computer system 100 further includes computer storage media in the form of volatile and/or non-volatile memory such as Read Only Memory (ROM) and Random Access Memory (RAM). RAM typically contains data and/or program modules that are accessible to and/or operated on by computer processor 120. That is, RAM may include application programs, such as the functional modules of the system of the present invention, and information in the form of data. The computer system 100 may also include other removable/non-removable, volatile/non-volatile computer storage and access media. For example, the computer system 100 may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may be connected to other peripheral output devices, such as printers (not shown).

The computer processor 120 may be configured and arranged to perform functions and steps embodied in computer instructions stored and accessed in any one or more of the manners described. The functions and steps, such as the functions and steps of the present invention to be described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor 120, instruct the computer processor 120 to perform one or more processes or acts described herein, and/or various examples, variations and combinations thereof Such instructions may be written in any of a plurality of programming languages, for example, Java, Visual Basic, C, or C++, Fortran, Pascal, Eiffel, Basic, COBOL, XML, HTML and the like, or any of a variety of combinations thereof. The computer-readable medium on which such instructions are stored may reside on one or more of the components described above and may be distributed across one or more such components.

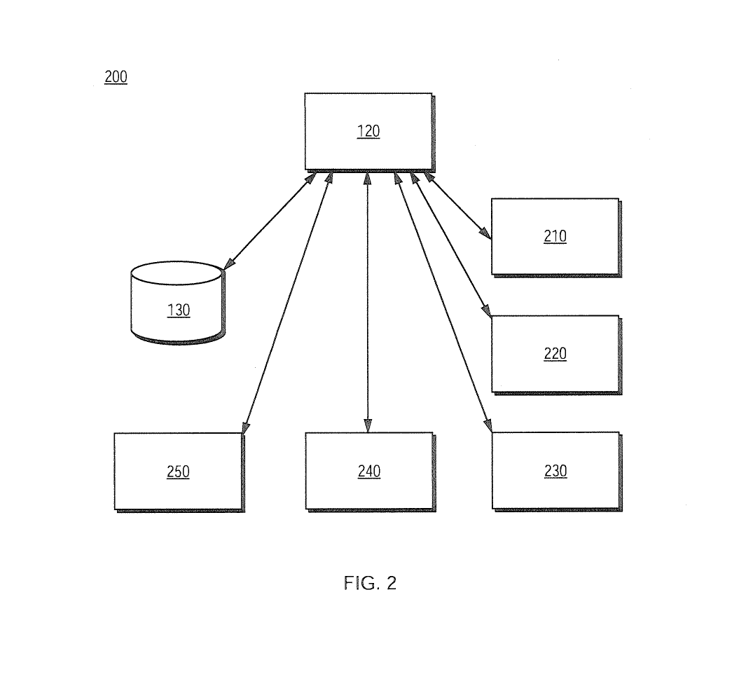

With reference to FIG. 2, a medication refill advisor system 200 of the present invention includes a plurality of functions embodied in one or more computer programs executable through the computer processor 120 of the computer system 100. Primary functions of the system 200 include a medication information input function 210, a patient information input function 220, a refill protocol determination function 230, a refill analysis function 240 and a refill advisory output function 250. The system 200 includes other functions referred to herein, and each of the identified primary functions to be described may include one or more sub-functions. The system 200 represented in FIG. 2 may be embodied in one or more computer programs and one or more computer systems. It may be embodied in software, hardware, firmware or any combination thereof. The functions shown may be performed or executed through computing means such as the computer processor 120 as a single computing mechanism, or through a plurality of computer processors represented by processor 120.

The system 200 may include one or more databases represented by database 130, which database may be embodied in the computer processor 120 or in one or more other computer systems in electronic communication with the computer processor 120. It is to be noted that a model generated using the system 200 of the present invention, or any components thereof, may be used without specific presentation of the display of the computer system 100. For example, the output of refill information may be transferred among computer devices, or within a networked computing system, without specific presentation on a display. Further, the refill analysis function 240 may be used to perform calculations without requiring presentation on such a display.

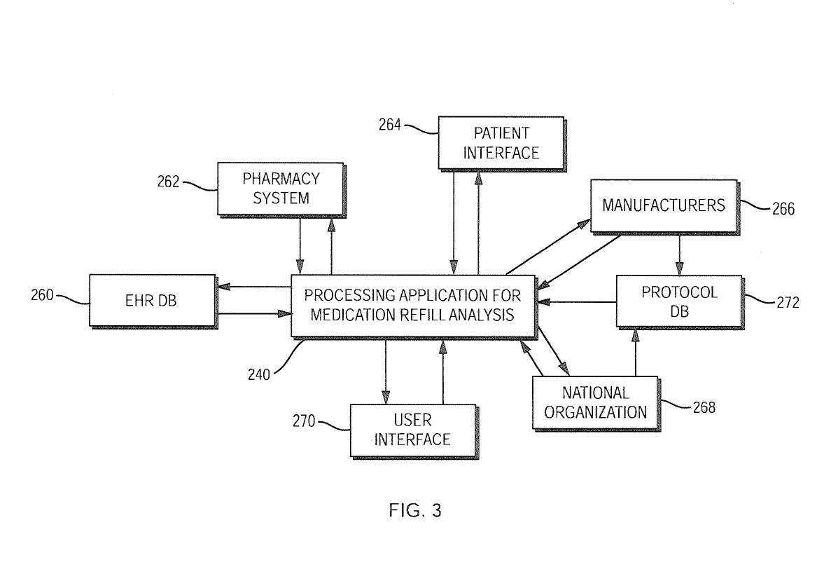

A simplified representation of the relationships among the functions of the system 200 is shown in FIG. 3. Referring to FIG. 3, medication information is gathered through the medication information input function 210, directly or indirectly, from one or more of an electronic health records (EHR) database 260, a retail or other type of pharmacy source 262, a patient 264, a medication manufacturer 266 and a national health organization 268, but not limited thereto. Patient information is gathered through the patient information input function 220, directly or indirectly, from one or more of the EHR database 260, the pharmacy source 262 and the patient 264, but not limited thereto.

The medication information gathered may be as comprehensive as is available and may be updated on a regular or sporadic schedule. For example, the medication manufacturer 266 may generate annual updates on the medications it makes, or it may generate ad hoc communications of medication information. The system 200 is set up such that that medication information may be inputted manually, such as by a system user interface 270, automatically, such as by electronic communication via computer links, or a combination of the two. Similarly, patient information gathered may be as comprehensive as is available and may be updated on a regular or sporadic schedule. For example, a patient may call into a doctor's office to register a name change, which is recorded in the EHR database 260, or the patient 264 may make an office visit and a blood pressure obtained, with that information included in the refill analysis.

The refill protocol determination function 230 gathers information from one or more of the medical manufacturer 266, the national organization 268, a collaborative among health care providers, and individual health care providers. The information gathered may be stored generally in the database 130 or in a specific protocol database 272, which itself may be part of the database 130 but may also be or form part of a national or international standards organization database. The refill protocol determination function 230 gathers any information considered to be of importance in making a determination about medication and medication refill guidelines. That information may include patient information on a group scale rather than on an individual scale. For example, the national organization 268 may have a study conducted on a group of 1000 people with respect to the use of a particular medication. The medical histories of those patients, or certain aspects of those histories, may be coordinated with information about their usage of a medication of interest to generate a guideline of the type of person for whom the medication is efficacious.

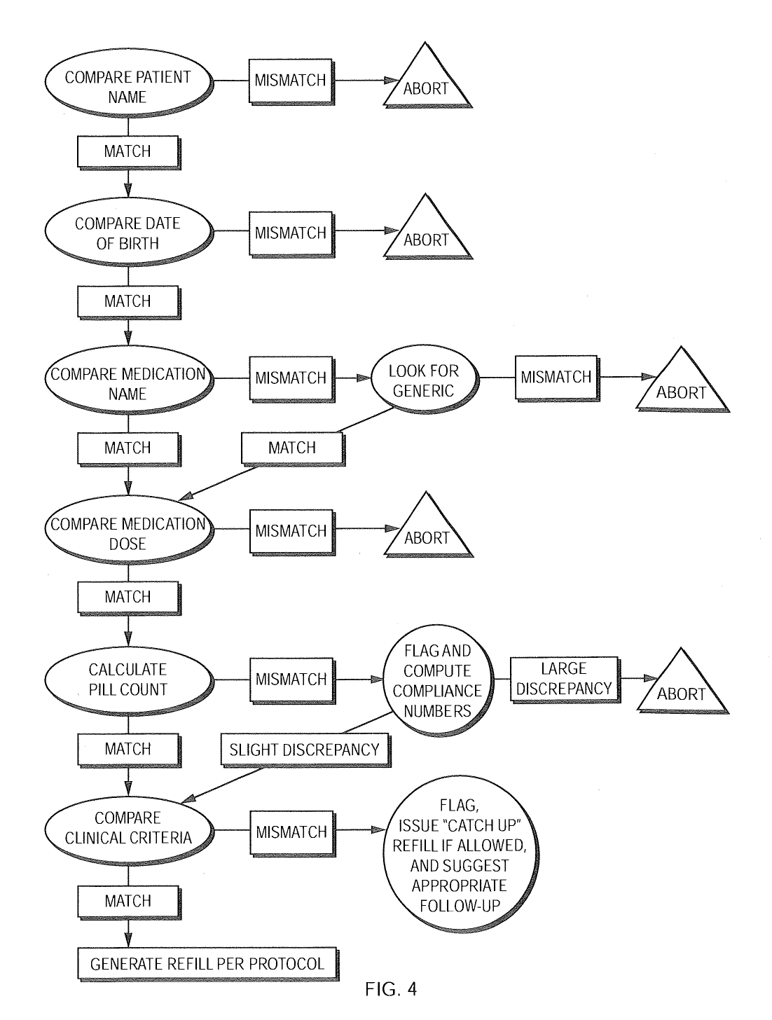

The refill protocol determination function 230 gathers the indicated information and also includes one or more protocol sub-functions, established as one or more algorithms, that are configured to generate refill protocols for all medications identified with the medication information input function 210. The protocols may be updated regularly or sporadically based on information gathered. The protocols established may be used by the system 200 to provide input to the refill analysis function 240. Examples of types of inputs to the refill analysis function 240 and the resulting actions used in generating refill protocols are shown in FIG. 4. The inputs and actions used to generate a protocol illustrated in FIG. 4 are representative only. Other inputs and/or actions could be used or inputs and/or actions that are depicted may not be used without departing from the scope of the invention.

As shown in FIG. 4, when executing the refill protocol determination function the system 200 compares information contained in the database 130 or 272 with the refill information that would be supplied by the user. If the data for a specific parameter match, the system 200 proceeds to the next parameter. If the data do not match, the system 200 recognizes this failure and aborts the protocol. For example, in FIG. 4 the system 200 compares the patient's name, date of birth, medication name, medication dose, pill count, and clinical criteria from database 130 or 272 with the information provided by the patient and/or healthcare provider. Some criteria may mismatch without aborting the protocol determination function. For example, if the medication name does not match, the system 200 will look for a generic equivalent. If the pill count does not match, the system 200 will compute the number of pills in the prescribing period and compare this with the number of days since the first fill date of the prescription. A slight discrepancy may only warrant a yellow flag indicating that the health care provider should discuss prescription compliance with the patient, and the system 200 will proceed, noting this follow-up. Dramatic non-compliance or very early refill attempts may prompt a red flag and the function is aborted by the refill advisor system 200. The system 200 functions in a similar manner when a mismatch between clinical criteria is found. Generally, the system 200 will flag the protocol as yellow and recommend a catch-up refill of the prescription so that an appropriate follow-up with a health care provider can be completed prior to reaching the aborting criteria.

The refill analysis function 240 is used directly by the health care provider to acquire advice that may be used in making medication refill decisions. That is, the system user represented as user interface 270 in FIG. 3 may gather patient information and medication information associated with a specific patient, and input that information, manually or automatically, into the refill analysis function 240. Relevant patient information includes, but need not be limited to, demographic data and clinical data, such as imaging or lab results, blood pressure, weight, prescription history, and visit history. The refill analysis function 240 correlates that inputted patient and medication information with one or more refill protocols established by the protocol determination function 230. The refill analysis function 240 may identify one or more refill protocols for the health care provider to select from for that patient or it may generate one or more follow up questions for the system user to answer to assist in ensuring that enough information has been gathered to resolve the appropriate protocol to be designated.

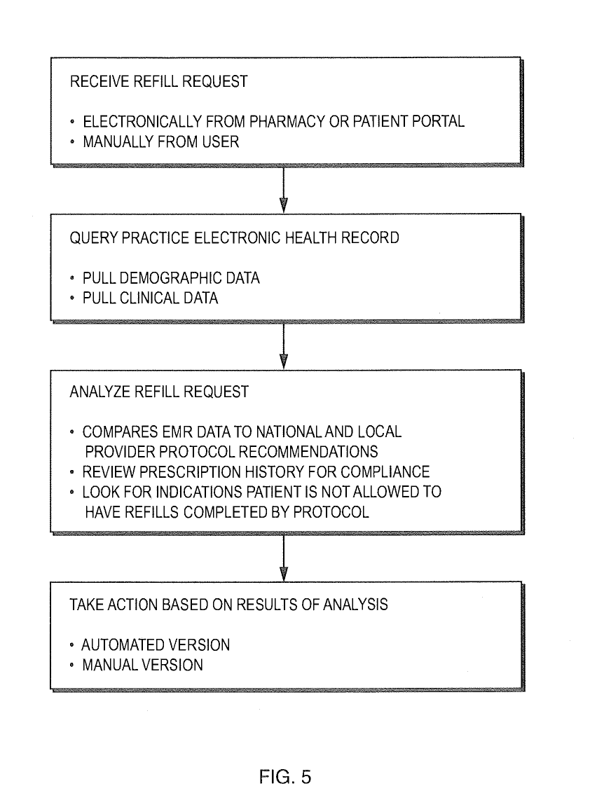

An example of a refill analysis process flow is represented in FIG. 5. Each step of the work flow can include sub-parts. For example, in the first step, where the system 200 receives the refill request, before moving on to the next step the system 200 may confirm that the medication is of a type for which a refill protocol can be generated. Non-protocol medications such as antibiotics or narcotics will simply result in a “stop” protocol being generated. Protocol medications allow the system 200 to move to the next step. The third step in FIG. 5 is an analysis of the refill request. To do so, the system 200 compares EHR data for the patient to both national and local provider protocol recommendations for monitoring and visits, reviews the prescription history for compliance, and looks for any indication that the patient is not allowed to have refills completed by automated protocol.

As further shown in FIG. 5, the system 200 takes action based on the results of this analysis and can proceed automatically to issue the refill to a pharmacy or to manually indicate the results. In the automatic version, if the analysis results in a “go,” the system 200 issues a refill instruction to the appropriate pharmacy, generally for a specified time frame (e.g. 90 days). The health care provider is also notified of the refill and any status change with respect to monitoring parameters so that any needed action (ordering lab tests, scheduling appointments, etc.) can be taken prior to the next refill. If the analysis results in a “stop,” the system 200 sends notification to the health care provider that the patient is ineligible for protocol refill and indicates the reason (ineligible medication, non-compliance, etc.). In the manual version, the system 200 displays the results to the user in any appropriate manner, including any recommendations as to the number of days the user has to issue the refill and as to any testing or appointments to schedule as a follow-up. The user has the option to copy this data into the patient's EHR and complete the refill, if appropriate.

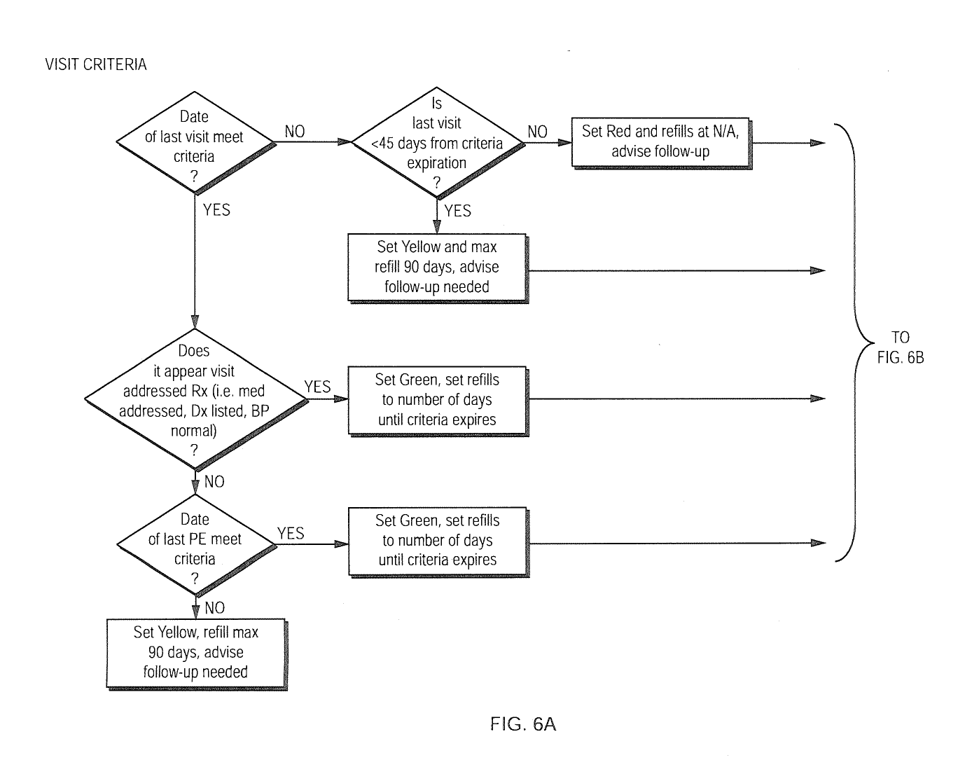

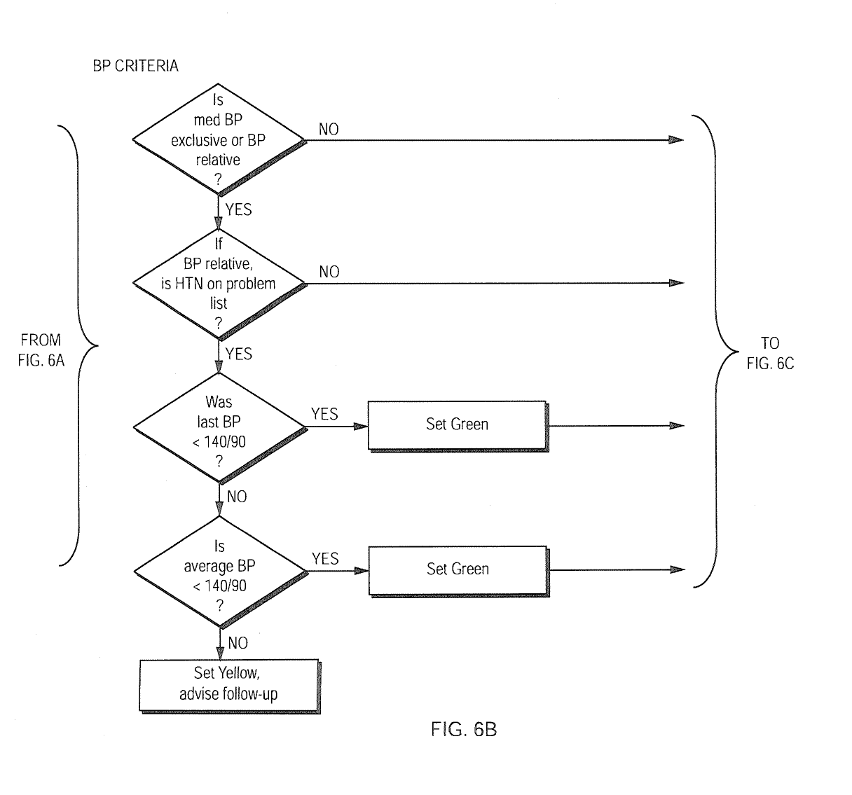

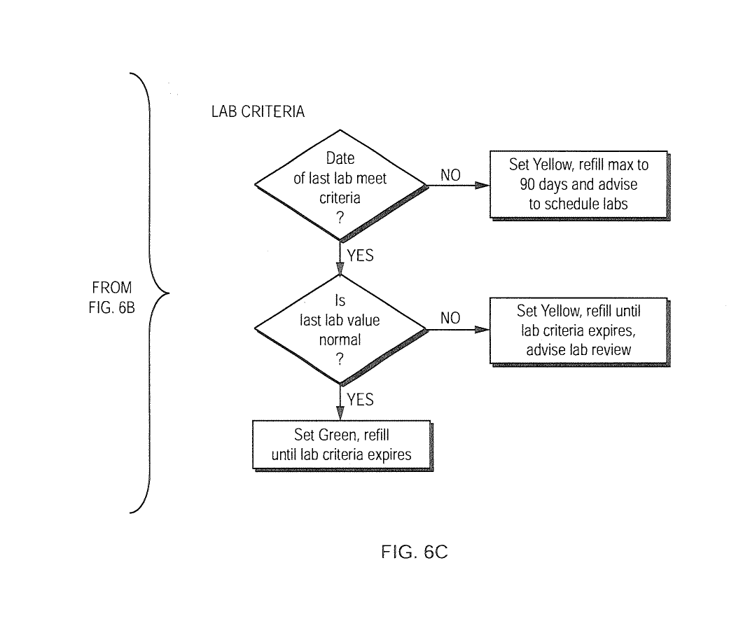

Once a refill recommendation is generated by the refill analysis function 240, a health care provider has the option to carry out a review to determine the applicability of the refill recommendation generated. An example of a criteria review that a health care provider might carry out is shown in flow diagram form in FIGS. 6A-C. FIGS. 6A-C show three general categories of criteria to evaluate, although this is merely representative. The health care provider may consider each criterion individually, and meeting one criterion allows the health care provider to move onto the next one. For example, FIG. 6A shows visit criteria, and these should be passed before moving to the blood pressure (BP) criteria shown in FIG. 6B. If the BP criteria are met, the health care provider moves to the lab criteria shown in FIG. 6C. If any criterion is not met, the health care provider may choose to refill the prescription one time and flag it yellow to indicate that an appropriate follow-up is required. After reviewing these criteria, the health care provider may generate an advisory, which is a summary of the recommendations for each criteria. This advisory establishes what color to assign to the refill: red supercedes yellow which supercedes green. The refill may also have a recommendation, such as a one-time refill with an office visit or lab test to be scheduled.

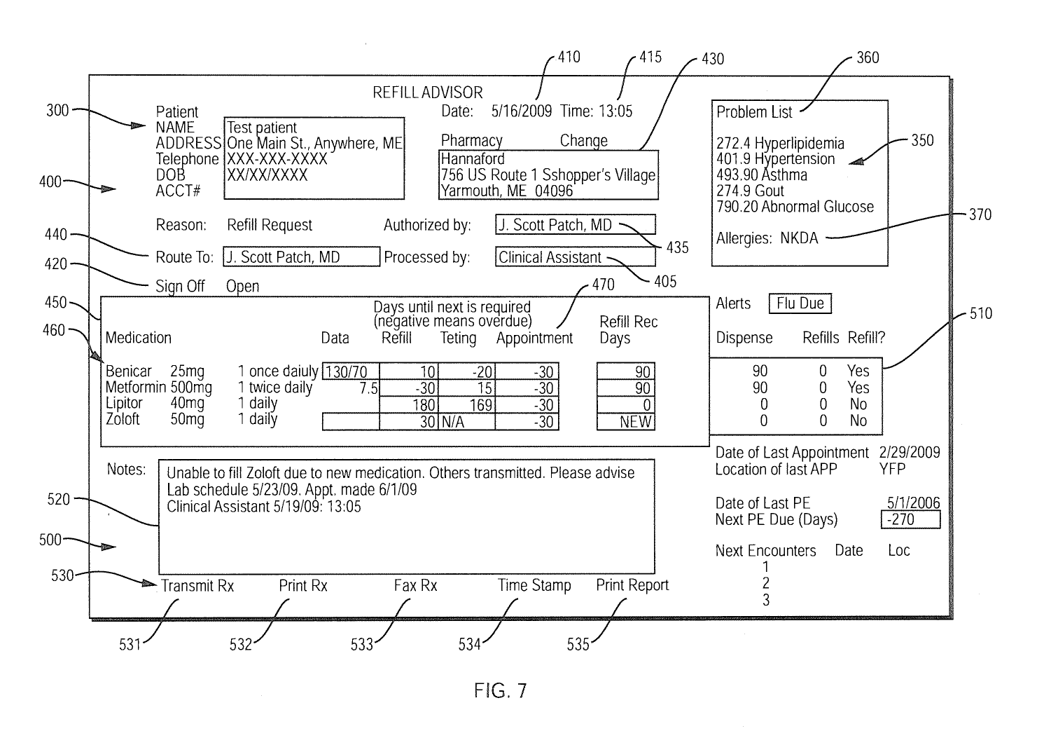

The refill analysis function 240 is coupled to the refill advisory output function 250 to output the refill protocol determined to be most applicable for the patient and medication information gathered. Optionally, more than one protocol may be outputted, in which case an appropriate health care provider may be required to make a selection of one of the protocol options generated. The refill advisory output function 250 may be coupled only to the user interface 270 of the system 200 so that only the health care provider with direct contact to the patient can observe the protocol information. In that case, the system 200 is configured to communicate refill instructions only to one or more of the pharmacy 262 and the patient 264. An example of the output information provided to the clinician for review is shown in FIG. 7. Optionally, the protocol information may be outputted to others including, for example, the pharmacy 262. In that optional case, the system 200 is configured so that it communicates directly with one or more of the pharmacy 262 and the patient 264 to ensure that the basis of the refill instructions established may be observed by the pharmacy 262 and/or the patient 264.

With reference to FIG. 7, one or more functions of the system 200 enable an authorized user to view and input patient and medication information and to observe refill protocol information. FIG. 7 is a graphical representation of an example of the screen viewed by the user in making a refill decision in an effective and rapid manner. The system 200 embodied in a computer program is activated or launched by clicking on an icon representing the program, or otherwise initiating application opening through desktop activation methods well known to users of computer programs. Upon activating the system 200, the computer processor 120 enables the user to observe on display 103 the screen shown in FIG. 7. The screen of FIG. 7 depicts a graphical user interface, which enables the user to see one or more interactive boxes and to manipulate the content of one or more of the boxes through user inputs, generally either with keystrokes of the keyboard 101, and/or clicking or clicking and dragging with the mouse 102 icons, categories, items, elements, formulas, and the like represented on the display 103.

The graphical user interface includes a first general patient information box 300, a second general patient information box 350, a patient information input box 400, a medication refill specific information box 450 and an actions taken input box 500. The first patient information box 300 includes gathered patient information of any type of interest, as gathered in the manner previously described. The information contained therein is just one example and the information that may be included is not limited to the particular information shown.

The second general patient information box 350 includes patient information gathered in the manner previously described that is directed to particular conditions of the patient that may be specifically relevant to the patient's medication protocols. In the example shown, the information may be divided into a patient problems list 360 and a patient allergies list 370, but is not limited thereto.

The patient information input box 400 is configured in a selectable manner for the user to introduce patient information gathered from any of the sources previously identified and may also be populated with information provided by a clinician or any person associated with the health care provider in communication with the patient 264, the pharmacy 262, or the like. The representative patient information input box 400 of FIG. 7 includes a user identification box 405, a date box 410, a time box 415, a status box 420, the first general patient information box 300, a pharmacy box 430, a responsible prescriber identification box 435, and a designated user selection box 440. The person contacted by a patient calling or communicating electronically with a patient identifies himself/herself, and lists the date and time of the contact by the patient. The user inserts the patient's information in box 300 and gets a listing of the patient's pharmacy contact information in box 430. The user's action triggers the generation of medication and health information as previously gathered, which information is output to box 450. The user may modify information in the patient information input box 400 but not in the box 450. Any steps, actions, or additional information gathered is inserted in the boxes 420, 430, 435 and 440 as necessary.

The information output in the form of specific information box 450 cannot be modified by the system user. Instead, that table of patient information is generated by the refill analysis function 240 and then output to the user interface display by refill advisory output function 250. That information contained in box 450 may either be used by the system user to generate medication refill instructions, communicate with a clinician about the refill request, contact a designated pharmacy with refill instructions, or any combination thereof. Information associated with the action taken is then input into box 500. Within patient information input box 400, there are two additional interfaces. Box 460 contains an interface to the EHR database 260 where the user can access generic versus brand names. Box 470 includes a function which will allow an interface with the underlying EHR database 260 such that the user will be able to schedule tests and appointments from within system 200.

Box 500 includes an input box 510 for dispense and refill authorization, an action taken insert box 520, and an additional steps toolbar 530 with menu options. One of the menu options of the toolbar 530 is an electronically transmit script 531, a print script 532, a fax script 533, a time of action indication 534, and a print report 535. Any of the script menus 531, 532 and 533 may be selected by the user to output prescription refill instructions and authorization based on the analysis performed through the refill analysis function 240. Additionally, the user of the system 200 may click on the print report menu 535 to generate a report of information related to the patient, the medication refill decision, or both.

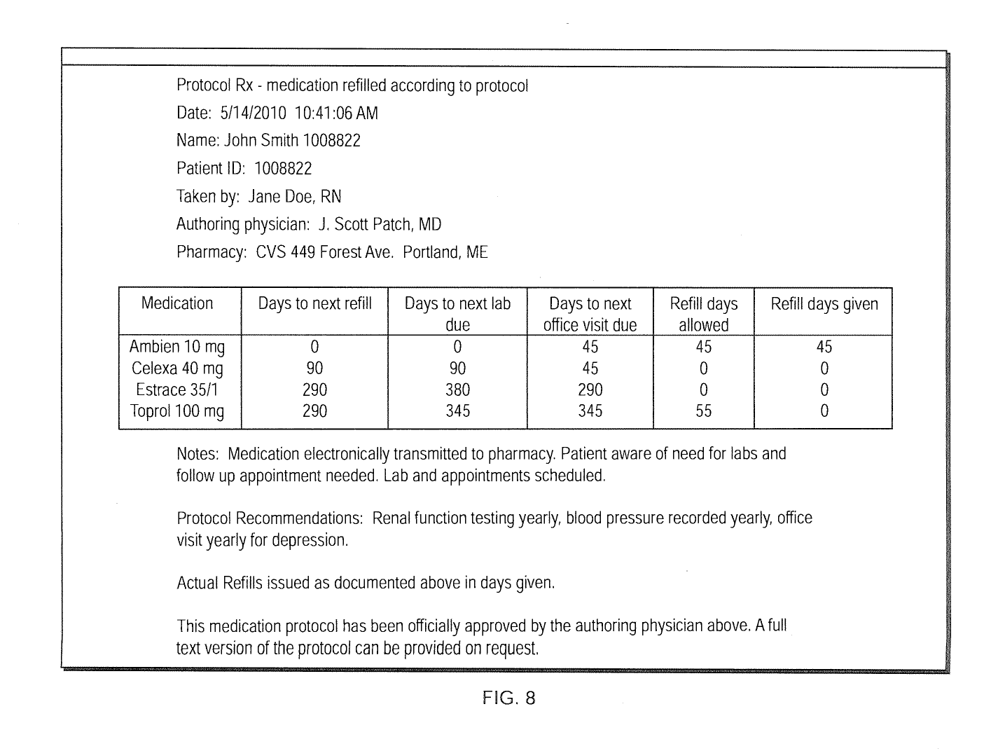

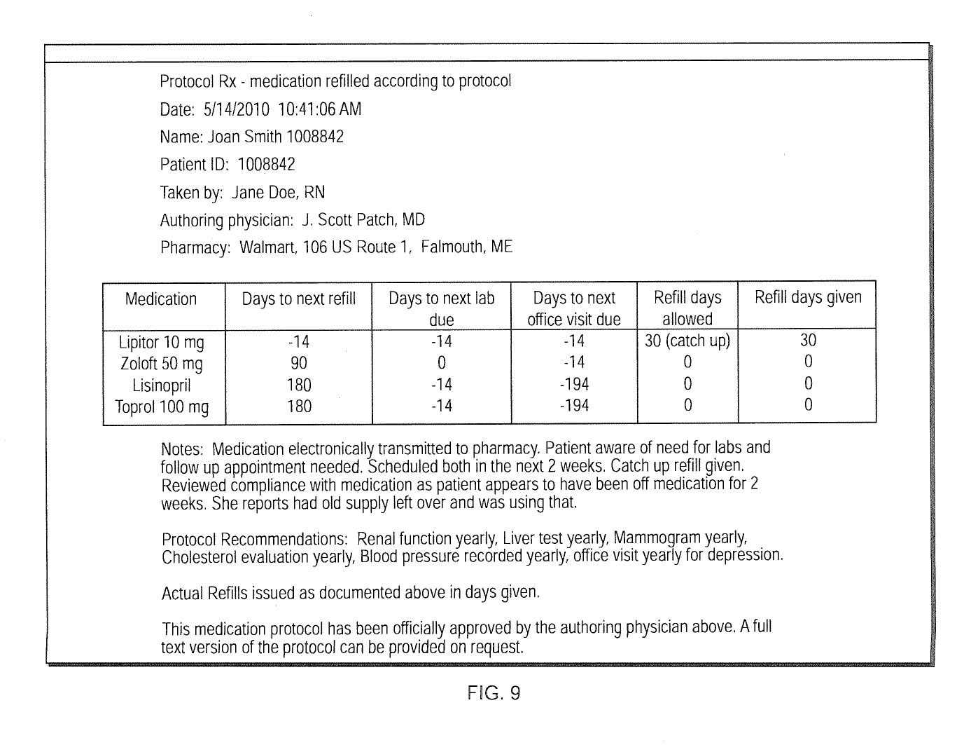

FIGS. 8 and 9 show examples of reports that may be generated upon clicking the print report menu 536. In FIG. 8, the reported information is an output of patient information for a particular patient, the medication for whom the refill has been requested, details of the refill instructions, and follow-up information about the medication and additional patient care tasks to be performed. Such tasks include, but are not limited to, laboratory tests to be performed, doctor's visits to be completed and review of the patient's blood pressure. Additionally, the report may also include other medications taken by the patient (as shown in FIG. 8). In FIG. 9, the report is a listing of refill information for a different patient. The information contained in FIGS. 8 and 9 has been generated using the refill analysis function 240 and the refill advisory output function 250. The information observable in the reports may be supplied to the clinician for review and confirmation, it may be stored in the database 130, it may be produced to an external recipient, such as a pharmacy 262, a national organization 268 or the like or any combination of these options.

In the present invention, the user may particularly be a pharmacist who has been contacted by a patient to refill a prescription. The pharmacist activates the program, inputs the patient's name and can determine from the generated report whether the refill is a “go,” a “caution” or a “stop,” and then complete the refill and advise the patient about whatever sort of action undertaking must be performed before the next refill, or not complete the refill and notify the patient to either contact the health care provider or of the reason for the no-refill action. In this way, the pharmacist and patient are no longer required to wait for the interaction with the health care provider in order to complete the refill. Further, the pharmacist may be permitted access to relevant patient information through the system 200, which information may be applicable to the prescription refilled.

The present invention as described is a system and related method for information gathering, medication refill protocol development, medication refill analysis, automated refill recommendation output, and medication refill at a pharmacy, whether a private, commercial, public or not-for-profit pharmacy. The invention has been described with specific reference to certain system functions and method steps configured to enable a computing system to perform the actions described. The invention is not limited to the specific arrangements and outputs described herein. All equivalents are deemed to be within the scope of the invention as described by the following claims.

1-20. (canceled)

21. A medication refill advisor system comprising:
a. a computer device executing computer-executable instructions;
b. a medication information database accessible through the computer device;
c. a medication information input function executable on the computer device for gathering medication information and transferring it to the database;
d. a patient-specific information input function executable on the computer device for gathering patient-specific information and transferring it to the database, wherein the patient-specific information includes laboratory data, visit data and vital signs;
e. a refill protocol determination function executable on the computer device for gathering medication prescription and refill guideline information and transferring it to the database; and
f. a refill analysis function executable on the computer device for:
i. receiving medication refill requests,
ii. correlating the medication information, the patient-specific information and the refill guideline information, and
iii. generating one or more of one or more refill protocol recommendations and one or more follow-up patient questions based on the correlated medication information, patient-specific information and refill guideline information prior to issuing one or more medication refill instructions.

22. The system of claim 21 further comprising a refill advisory output function executable by the computer device for outputting the one or more medication refill instructions based on the recommendations generated by the refill analysis function.

23. The system of claim 22, wherein the output of the refill advisory output function is an automatic pharmacy refill authorization.

24. The system of claim 23, wherein the refill output advisory function is configured to automatically authorize a pharmacy to refill a medication on a selectable basis.

25. The system of claim 21 further comprising a specific refill protocol database, which may or may not be a part of the medication information database.

26. The system of claim 21, wherein the medication information is gathered from a plurality of sources.

27. The system of claim 26, wherein the medication information is arranged for comparison with clinical data.

28. The system of claim 21, wherein the refill analysis function receives electronic or manually entered medication refill requests.

29. The system of claim 21, wherein the medication information input function gathers medication information either directly or indirectly from one or more of an electronic health records database, a pharmacy source, a medication manufacturer, a national health organization and a patient.

30. The system of claim 21, wherein the patient-specific information input function gathers patient-specific information either directly or indirectly from one or more of an electronic health records database, a pharmacy source, and a patient.

31. The system of claim 21, wherein the refill protocol determination function gathers information either directly or indirectly from one or more of a medical manufacturer, a national organization, a collaborative among health care providers, and individual health care providers.

32. The system of claim 21, wherein the refill analysis function is used directly by a health care provider to acquire automated advice useful in making medication refill protocol decisions.

33. The system of claim 22, wherein the refill analysis function is coupled to the refill advisory output function to output the refill protocol automatically determined to be most applicable for the patient in relation to the medication information gathered.

34. The system of claim 21, wherein the refill analysis function is configured to compare the parameters for a specific medication against established protocols.

35. The system of claim 22, wherein the automated refill advisory output function outputs one or more refill protocols.

36. The system of claim 35, wherein the automated refill advisory output function outputs the one or more refill protocols directly to a pharmacy.

37. A computer-implemented method of outputting one or more medication refill advisory protocols, the computer-implemented method using a computer device having (i) a plurality of computer-implemented functions, and (ii) a database, the computer-implemented method comprising the steps of:
a. executing a medication information input function of the computer device that gathers medication information and transfers it to the database;
b. executing a patient-specific information input function that gathers patient-specific information and transfers it to the database, wherein the patient-specific information includes laboratory data, visit data and vital signs;
c. executing a refill protocol determination function that gathers medication prescription and refill guideline information and transfers it to the database; and
d. executing a refill analysis function that:
i. receives medication refill requests;
ii. correlates the medication information, the patient-specific information and the refill guideline information; and
iii. generates one or more of one or more refill protocol recommendations and one or more follow-up patient questions in response to each of the medication refill requests based on the correlated medication information, patient-specific information and refill guideline information prior to issuing one or more medication refill instructions.

38. The method of claim 37 further comprising the step of executing a refill advisory output function that outputs to a health care provider the one or more medication refill instructions based on the recommendations generated by the refill analysis function.

39. The method of claim 38, wherein the health care provider is a pharmacist.

40. The method of claim 37, wherein the recommendations include either making a recommendation of completing a refill and advising a patient about what action is necessary before the next refill, or making a recommendation of not completing the refill and advising the patient of the reason for the recommendation not to complete the refill.
